(19) United States
(12) Patent Application Publication
(10) Pub. No.: US 2005/0076680 A1
(43) Pub. Date: Apr. 14, 2005

(54) Method and apparatus for manufacturing optical fiber preforms using the outside vapor deposition process

(76) Inventors: Hyung-soo Shin, Kangnam-gu (KR); Man-soo Choi, Chungrang-gu (KR); Chan-yong Park, Kangseo-gu (KR); Bong-hun Lee, Kyunggi-do (KR)

Correspondence Address: Cooper & Dunham, 1185 Avenue of the Americas, New York, NY, 10036, US

(21) Appl. No.: 10/494,796

(22) PCT Filed: Aug. 11, 2003
(86) PCT No.: PCT/KR03/01612

(30) Foreign Application Priority Data
Aug. 12, 2002 (KR) 10-2002-0047605

(51) Int. Cl. C03B 37/018

(52) U.S. Cl. 65/421; 65/422; 65/531

(57) ABSTRACT

Disclosed is a method and apparatus for manufacturing an optical fiber preform, using an outside vapor deposition (OVD) process, in which deposition and sintering processes can be continuously carried out in an OVD apparatus. The manufacturing apparatus includes a vertically-extending carriage, and a sintering unit installed at the upper end of the carriage, and adapted to sinter a clad deposited on a circular target rod. The sintering unit is a hydrogen/oxygen flame burner or a furnace using a heating source that doesn't generate H₂0 or hydroxyl groups (OH) during a heating operation thereof The manufacturing method includes a deposition step of depositing a clad on the circular target rod while reciprocating a deposition burner, and a sintering step of sintering the clad while reciprocating the sintering unit in a state in which the circular target rod deposited with the clad extends through the sintering unit.

### TECHNICAL FIELD

The present invention relates to a method and apparatus for manufacturing a preform, using an outside vapor deposition process, and more particularly to a method and apparatus for manufacturing a preform for production of an optical fiber to be used in an optical communication system, using an outside vapor deposition process, which can simplify the manufacturing process by continuously carrying out deposition and sintering processes, in this order, reducing the volume of the manufacturing apparatus.

### BACKGROUND ART

Typically, optical fibers are made through a chemical deposition process because they require a high purity.

For such a chemical deposition process adapted to make optical fibers, there is a modified chemical vapor deposition (MCVD) process, an outside vapor deposition (OVD) process, a vapor phase axial deposition (VAD) process, etc.

There is also a plasma chemical vapor deposition (PCVD) process developed by Philips of Germany.

A general OVD process will now be described in brief.

As shown in FIG. 1, that is, a schematic view illustrating a general OVD apparatus, a deposition burner 18 is arranged beneath a rotating circular target rod 22 made of a pure silica material, reciprocable on a lathe 10 in an axial direction of the target rod 22 by a feeding motor 16. The deposition burner 18 serves to inject fuel such as hydrogen and oxygen, shield gas, such as nitrogen and argon, and a chemical substance, such as SiCl₄.

As hydrogen and oxygen injected, as fuel, from the deposition burner 18 are combusted, the temperature of the chemical substance, SiCl₄, injected from the deposition burner 18 increases abruptly at a region near the surface of the deposition burner 18. When the chemical substance reaches a temperature exceeding its chemical reaction temperature, about 1,300° C., it begins to undergo oxidation and a hydrolysis, thereby producing a silicon oxide such as SiO₂ in the form of particles, as follows:
SiCl₄+O₂→SiO₂+2Cl₂ (Oxidation)
SiCl₄+2H₂O→SiO₂+4HCl (Hydrolysis)

The produced particles are moved along with high-temperature gas injected from the deposition burner 18, and then deposited on the circumferential surface of the circular target rod 22, which is maintained at a relatively low temperature in accordance with a thermophoresis phenomenon caused by a temperature gradient exhibited around the circular target rod 22.

Although the particles have a grain size of about 0.1 μm at the initial stage of production, they ultimately reach an increased grain size of about 0.25 μm as they are subjected to collision, coalescence, coagulation, etc. Such particles are called “soot”.

As the deposition burner 18 reciprocates repeatedly, the particles injected from a nozzle 17 of the deposition burner 18, that is, soot 19, are deposited on the circular target rod 22, thereby forming a clad 42 on the circular target rod 22. In order to vary the refractive index of each deposited layer formed by one reciprocation of the deposition burner 18, the composition of chemical gas may be varied prior to the reciprocation of the deposition burner 18.

For example, upon depositing an initial layer of the cladding 42, which will form the central portion of an optical fiber to be manufactured, an adjusted amount of germanium oxide (GeO₂); may be used along with silicon oxide (SiO₂) to control the refractive index of the cladding 42. The adjusted amount of GeO₂ may be provided by oxidation of germanium chloride (GeCl₄) supplied in an adjusted amount upon the deposition of the clad 42.

The OVD apparatus is provided at its top with an exhaust hood 24 in order to exhaust the remaining undeposited soot, and hot gas.

Once the clad 42 has formed to have a multilayer structure with a predetermined deposition thickness, the circular target rod 22 is separated from the clad 42.

Thereafter, the clad 42 is subjected to collapsing, sintering and dehydration processes in a furnace (not shown) maintained at a temperature of 1,400 to 1,600° C. Under these conditions helium (He), oxygen (O2), and chlorine (C12) gas are introduced into the central hole defined in the clad 42 by the separation of the circular target rod 22. As a result, a transparent optical fiber preform having a circular rod shape is obtained.

The dehydration process may be carried out simultaneously with the sintering process. The reason for carrying out the dehydration process is that if the optical fiber preform is manufactured in a state in which H₂O molecules and hydroxyl groups (OH) are present in the soot, it may generate adverse affects on the characteristics of the resultant optical fiber.

Accordingly, it is necessary to remove hydroxyl groups by carrying out a dehydration process in the sintering furnace.

In the dehydration process, the following chemical reaction is generated with Cl₂ gas acting as the dehydrating gas:
2H₂O+2Cl₂→4HCl+O2
2SiOH+2Cl₂→2SiCl+2HCl+O2

After the dehydration, the optical fiber preform is drawn to a diameter of about 125 μm while being heated again in the furnace, which is maintained at a temperature of 1,800 to 2,200° C., and the preform is coated with a polymer having a thickness of about 60 μm, thereby forming an optical fiber.

Meanwhile, the process to which the present invention is applied is an over sooting process. This over sooting process is often called a “soot over cladding” process. The over sooting process is similar to the above mentioned general CVD process in terms of over sooting. However, the over sooting process is not adapted for manufacture of a primary preform, as in the general OVD process, but adapted for manufacture of a larger secondary preform.

An enlarged preform has an advantage in terms of manufacturing costs because an increased yield per preform can be expected.

The over sooting process uses, as a circular target rod, the primary preform manufactured in the above mentioned general OVD process. Accordingly, it is possible to manufacture a preform with an increased volume by carrying out the deposition of soot up to the deposition thickness limit allowed by the manufacturing apparatus used in the over sooting process.

In accordance with the over sooting process, soot is deposited on a circular target rod in the same manner as the above mentioned general OVD process, to form a porous clad layer on the circular target rod, under the condition in which the circular target rod is prepared by a core preform manufactured in accordance with an MCVD or OVD process, thereby forming a porous soot preform. This porous soot preform is heated under a dehydrating gas atmosphere so that it is sintered. Thus, an enlarged optical fiber preform is manufactured.

The over sooting process can be substituted for a rod in tube (RIT) process adapted to achieve diameter enlargement of an optical fiber preform manufactured in accordance with a MCVD process currently in widespread use. In particular, the over sooting process is inexpensive as compared to the RIT process, because it dispenses with the quartz tube required in the RIT process. In addition, it can be said that the over sooting process is a process not influenced by the demand and supply of; quartz tubes required in chemical vapor deposition (CVD) processes to manufacture optical fibers.

Conventional techniques used to manufacture preforms are disclosed in, for example, U.S. Pat. No. 5,296,012 disclosing a deposition apparatus for attaching SiO₂ particles to a preform, U.S. Pat. No. 4,741,748 disclosing a specific sintering furnace, and U.S. Pat. Nos. 4,304,583 and 4,629,485 respectively disclosing sintering methods using dehydrating gas.

In accordance with such conventional techniques, a preform prepared by an OVD process or over sooting process is subjected to a deposition process in the above mentioned deposition apparatus so that SiO₂ particles are deposited on the preform. Thereafter, the preform is cooled to a certain temperature, and then fed to a sintering apparatus using the above mentioned specific sintering furnace. The preform is subjected to a sintering process in a heated state in the sintering furnace maintained at high temperature so that it is vitrified, so as to be used as an optical fiber preform.

However, the preform prepared by the above mentioned conventional OVD process may have a difference in soot density between its central portion and its peripheral portion because the distance between the outer surface of the preform and the deposition burner is reduced because the outer diameter of the preform increases as the deposition proceeds. For this reason, longitudinal cracks may be formed in the preform before the deposition is completed. Such a soot density difference results in a reduction in soot density, and thus, an increase in deposition volume. In order to sinter such a preform with an increased deposition volume, the sintering apparatus must be enlarged. This also creates an increase in installation costs.

Also, there is a problem in that the sintering apparatus must be equipped with a device for processing the noxious gas association with the dehydration process.

Furthermore, the sintering process must be prolonged in order to sufficiently sinter the bulky preform. Also, the soot deposited on the preform may be damaged while transferring the preform from the lathe to the sintering apparatus because the bonding force of the soot to the surface of the preform is low. Even when the deposited soot is partially damaged, the preform itself may not be used.

In addition, a large amount of time is required in the preform transferring procedure because the deposition process and the sintering process are carried out in different installations, respectively. The procedure of cooling the preform prior to the preform transferring procedure also requires a large amount of time.

### DISCLOSURE OF THE INVENTION

The present invention has been made in view of the above mentioned problems, and an object of the invention is to provide a method and apparatus for manufacturing an optical fiber preform which can continuously carry out the deposition and sintering processes involved in the outside vapor deposition (OVD) and over sooting methods, in this order, by installing a deposition burner and a sintering unit to be arranged adjacent to each other. This will reduce the sintering furnace installation costs, while at the same time simplify the manufacturing process, thereby reducing the manufacturing costs.

Another object of the invention is to provide an apparatus for manufacturing an optical fiber preform which includes a sintering unit capable of using a hydrogen/oxygen flame burner or furnace, in particular, a furnace producing no hydroxyl group (OH), thereby providing maximal hydroxyl group removal efficiency.

Another object of the invention is to provide a method for manufacturing an optical fiber preform in which the deposition and sintering processes are carried out, in this order, at every reciprocation of the deposition burner: This will effectively suppress the formation of cracks in the preform due to the non-uniformity of soot density caused by the variation in the outer diameter of the preform which can occur as the traditional deposition process proceeds.

The present invention provides a method for manufacturing an optical fiber preform using an outside vapor deposition process, comprising: a deposition step of injecting soot from a deposition burner onto a circumferential surface of a circular target rod, thereby depositing a clad on the circular target rod; a sintering step of sintering the clad deposited on the circular target rod by a sintering unit arranged adjacent to the deposition burner while being integral with the deposition burner; and repeatedly carrying out the deposition step and the sintering step, in this order.

The present invention also provides an apparatus for manufacturing an optical fiber preform, using an outside vapor deposition process, comprising: a deposition burner for injecting soot onto a circular target rod, thereby depositing a clad on the circular target rod; and a sintering, unit arranged adjacent to the deposition burner, and adapted to sinter the clad deposited on the circular target rod, wherein the deposition burner and the sintering unit are continuously and repeatedly reciprocated, in this order.

Preferably, the deposition and sintering steps are carried out by reciprocating the deposition burner in a longitudinal direction to the circular target rod in accordance with the guiding operation of a rotating rail rotated in normal and reverse directions at intervals predetermined by a feeding motor, while rotating the circular target rod a rotating motor and by reciprocating the sintering unit in a longitudinal direction to the circular target rod in accordance with the guiding operation of the rotating rail, while rotating the circular target rod with the rotating motor, respectively.

The sintering unit may comprise a hydrogen/oxygen flame burner with a hollow semi-cylindrical shape that allows the circular target rod to extend through the hydrogen/oxygen flame burner. Alternatively, the sintering unit may comprise a furnace having a hollow cylindrical shape so that the circular target rod extends through the furnace.

Preferably, the furnace uses a heating source not generating H₂O or hydroxyl groups (OH) during the heating operation.

Preferably, the furnace is supplied with dehydrating gas so that dehydration occurs simultaneously with the sintering step in the furnace. The dehydrating gas may be one or more gaseous materials selected from a group consisting of He, Cl₂, SiCl₄, GeCl₄, BCl₃, HCl, POCl₃, PCl₃, TiCl₄, and AlCl₃.

Preferably, the sintering unit has an internal temperature of 1,200 to 1,700° C. during the sintering step.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic view illustrating a general OVD apparatus;

FIG. 2 is a schematic view illustrating an optical fiber preform manufacturing apparatus according to an embodiment of the present invention; and

FIG. 3 is a schematic view illustrating an optical fiber preform manufacturing apparatus according to another embodiment of the present invention.

### BEST MODE FOR CARRYING OUT THE INVENTION

Now, the present invention will be described in more detail in conjunction with embodiments thereof illustrated in the annexed drawings.

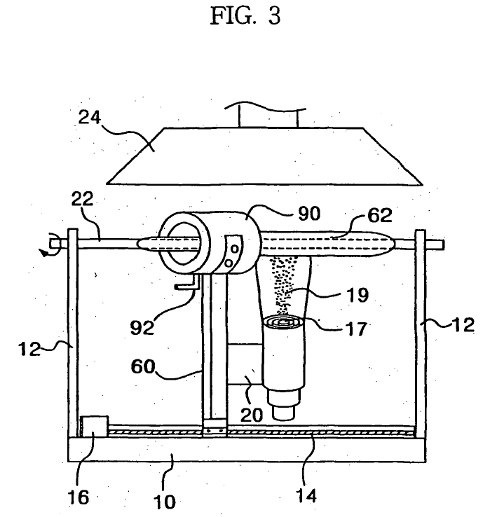

The present invention provides an optical fiber preform manufacturing apparatus which uses an outside vapor deposition (OVD) process. FIG. 2 is a schematic view illustrating an embodiment of the optical fiber preform manufacturing apparatus according to the present invention. FIG. 3 is a schematic view illustrating another embodiment of the optical fiber preform manufacturing apparatus according to the present invention.

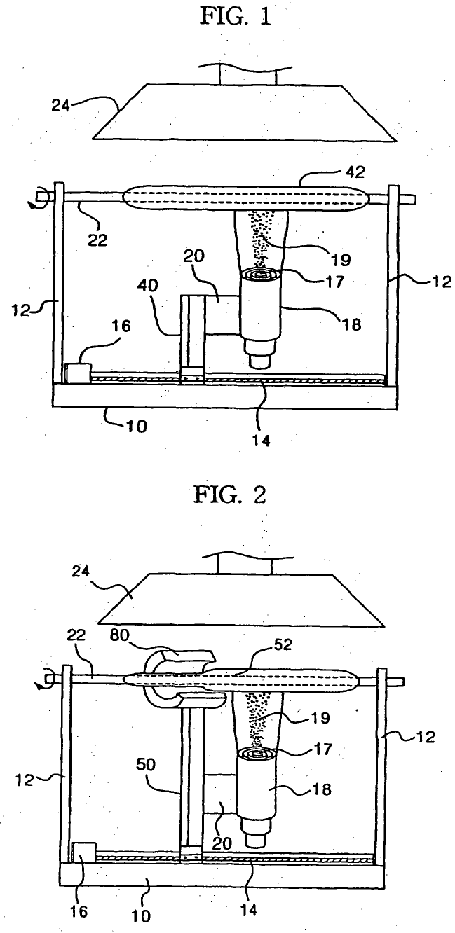

In FIGS. 2 and 3, respective constitutive elements corresponding to those of FIG. 1 are designated by the sane reference numerals, and description thereof will be omitted.

As shown in FIG. 2 or 3, the optical fiber preform manufacturing apparatus includes a deposition burner 18 adapted to inject soot 19 onto a rotating circular target rod 22, thereby depositing a clad 52 or 62 on the circular target rod 22, and a sintering unit arranged adjacent to the deposition burner 19 in such a manner that it is integral with the deposition burner 19, and adapted to sinter the clad 52 or 62 deposited on the circular target rod 22. The deposition burner 19 and sintering unit reciprocate repeatedly, in this order, in an axial direction to the circular target rod 22.

The present invention also provides a method for manufacturing an. Optical fiber preform, using an OVD process, in the optical fiber preform manufacturing apparatus of FIG. 2 or 3, in accordance with the present invention. The optical fiber preform manufacturing method includes a deposition step of injecting the soot 19 from the deposition burner 18 onto the outer circumferential surface of the rotating circular target rod 22, thereby forming the clad 52 or 62 on the circular target rod 22, and a sintering step of sintering the clad 52 or 62 deposited on the circular target rod 22 by the sintering; unit arranged adjacent to the deposition burner 18. In accordance with the present invention, the deposition step and sintering step are repeatedly carried out, in this order, as the deposition burner 18 and sintering unit reciprocate repeatedly, in this order.

For the configuration of the optical fiber preform manufacturing apparatus to deposit soot on the circular target rod 22, a pair of vertically-extending support members 12 are fixedly mounted on the lower end of a lathe 10 on opposite sides of the lathe 10. The support members 12 rotatably support opposite ends of the circular target rod 22 at its upper end. A rotating rail 14 is also rotatably mounted on the lathe 10 so that it rotates in normal and reverse directions at intervals of a predetermined by a feeding motor 16. The configuration further includes a vertically-extending carriage 50 or 60 coupled to the rotating rail 14 so as to move laterally, that is, in a longitudinal direction on the rotating rail 14, in accordance with rotation of the rotating rail 14. The deposition burner 18, which is also included in the configuration, is fixedly mounted to a fixed rib 20 extending laterally from the carriage 50 or 60 such that it is arranged beneath the circular target rod 22 supported by the support members 12. The deposition burner 18 is provided with a nozzle 17 for injecting soot 19 onto the circular target rod 22 to create a clad of a predetermined thickness, that is, the clad 52 or 62, thereby forming a preform.

In order to exhaust hot gas generated by the deposition burner 18 and any remaining undeposited residual soot, an exhaust hood 24 may be installed at the top of the optical fiber preform manufacturing apparatus.

In the embodiment of FIG. 2, the sintering unit includes a hydrogen/oxygen flame burner 80 having a hollow semi-cylindrical shape.

The hydrogen/oxygen flame burner 80 is installed at the upper end of the carriage 50. The carriage 50 is coupled, at its lower end, to the rotating rail 14, so that it moves laterally while being guided by the rotating rail 14 rotating on the lathe 10.

The rotating rail 14 is rotated by the feeding motor 16. Preferably, the feeding motor 16 is configured so that its rotation time and direction are controlled.

The rotating rail 14 is formed, at its circumferential surface, with a screw adapted to be engaged with the lower end of the carriage 50. Accordingly, when the rotating rail 14 rotates, the carriage 50 can reciprocate laterally, that is, in the longitudinal direction of the rotating rail 14, by virtue of the function of the screw.

Preferably, the movement speed of the carriage 50 is adjusted to allow the deposition burner 18 to form a clad of a sufficient thickness, as the clad 52, on the circular target rod 22.

It is also preferable for the deposition burner 18 fixedly mounted to the carriage 50 to be laterally spaced apart from the carriage 50 by a sufficient distance in order to prevent the flame of the deposition burner 18 projected toward the circular target rod 22 from coming into contact with the hydrogen/oxygen flame burner 80.

As described above, the circular target rod 22 is rotatably supported by the upper ends of the support members 12 fixedly mounted to the lathe 10 at opposite sides of the lathe 10.

Although not shown, the circular target rod 22 is connected to a rotating motor so that it rotates.

The circular target rod 22 extends through the interior of the hydrogen/oxygen flame burner 80 installed at the upper end of the carriage 50.

The hydrogen/oxygen flame burner 80 should use, as its heating source, a furnace not producing H₂O or any hydroxyl group (OH) during its heating operation. Alternatively, the hydrogen/oxygen flame may be equipped with a separate device for removing hydroxyl groups.

For the heating source not producing any hydroxyl groups, an electrical resistance heating source, an induced heating source or plasma heating source may be used.

In the embodiment of FIG. 3, the sintering unit includes a furnace 90 having a hollow cylindrical shape.

The furnace 90 is provided with a dehydrating gas supplying nozzle 92 for supplying dehydrating gas from an external supply source: into the interior of the furnace 90 to be used in the dehydration of the clad 62.

The dehydrating gas supplied into the furnace 90 through the dehydrating gas supplying nozzle 92 used to dehydrate the, clad 62 may be one or more gaseous materials selected from the group consisting of He, Cl₂, SiCl₄, GeCl₄, BCl₃, HCl, POCl₃, PCl₃, TiCl₄, and AlCl₃.

The apparatus of FIG. 3 has the same configuration as that of FIG. 2, except that the furnace 90 is installed at the upper end of the carriage 60. In the case of FIG. 2, the hydrogen/oxygen flame burner 80 is installed at the upper end of the carriage 50.

Now, the optical fiber preform manufacturing method carried out using the optical fiber preform manufacturing apparatus having the above configuration will be described with reference to FIGS. 2 and 3.

In accordance with the optical fiber preform manufacturing method of the present invention, the circular target rod 22 is first installed on the support members 12, and then rotated. Thereafter, soot 19 is injected from the deposition burner 18 onto the rotating circular target rod 22 while feeding the deposition burner 80 by the carriage 50 or 60, so that it is deposited onto the circular target rod 22, thereby forming a clad 52 or 62 on the circular target rod 22. The deposition process is carried out under the condition in which the deposition burner 18 installed to be laterally spaced apart from the vertical axis of the carriage 50 or 60 is uni-directionally or bi-directionally fed, until the clad 52 or 62 formed by deposition of the soot 19 has reached a predetermined thickness. Thereafter, the clad 52 or 62 is sintered by the sintering unit installed on the upper end of the carriage 50 or 60 adjacent to the deposition burner 18, under the condition in which the sintering unit is uni-directionally or bi-directionally fed.

For the sintering unit, the above described hydrogen/oxygen flame burner 80 having a hollow semi-cylindrical shape or the above described furnace 90 having a hollow cylindrical shape is used.

During the deposition process, the carriage 50 or 60 reciprocates repeatedly at a constant speed while being guided along the rotating rail 14. With every reciprocation of the carriage 50 or 60, the deposition burner 18 deposits the soot 19 onto the circumferential surface of the circular target rod 22 to a predetermined thickness.

Preferably, the circular target rod 22 rotates in order to allow the soot 10 to be uniformly deposited on the surface of the circular target rod 22.

The clad 52 or 62 formed by the deposition process has a relatively low density while having a large volume.

In the sintering process, the sintering unit mounted to the upper end of the carriage 50 or 60, that is, the hydrogen/oxygen flame burner 80 or the furnace 90, is reciprocated along the circular target rod 22 deposited with the clad 52 or 62, while surrounding the circular target rod 22. Thus, the clad 52 or 62 is sintered by the sintering unit.

Where the furnace 90 is used, dehydrating gas is supplied into the interior of the sintering unit through the dehydrating gas supplying nozzle 92 provided at the furnace 90 during the sintering process.

Dehydrating gas should be supplied because it is necessary to remove H₂O or hydroxyl groups (OH) contained in the soot during the deposition process.

The dehydrating gas may be one or more gaseous materials selected from the group consisting of He, Cl₂, SiCl₄, Gecl₄, BCl₃, HCl, POCl₃, PCl₃, TiCl₄, and AlCl₃.

During the sintering process, the sintering unit, that is, the hydrogen/oxygen flame burner 80 or the furnace 90, generates heat of temperatures ranging from 1,200° C. to 1,700° C.

Industrial Applicability

As apparent from the above description, in accordance with the optical fiber preform manufacturing method and apparatus of the present invention using an. OVD process, the deposition and sintering processes are continuously and repeatedly carried out, in this order, in such a fashion that the layer deposited in one deposition process is sintered prior to the next deposition process.

The sintering process can be achieved using a small-scale sintering unit. Accordingly, it is possible to reduce the installation costs and to achieve easy maintenance and repair.

In accordance with the present invention, the sintering process is carried out in a deposition apparatus having a noxious gas processing function. Accordingly, it is unnecessary to equip a separate noxious gas processing device in the sintering unit. It is also possible to prevent the preform from being damaged during its transfer to the sintering unit.

Since the sintering of the clad is carried out in the unit of deposited layers, it is possible to reduce the rate of products having a poor quality caused by bubbles formed in associated preforms.

It is also unnecessary to use separate processes to cool the preform for its transfer and mounting the preform to the sintering unit. Thus, manufacturing costs can be reduced.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A method for manufacturing an optical fiber preform, using an outside vapor deposition process, comprising:
a deposition step of injecting soot from a deposition burner onto a circumferential surface of a circular target rod, thereby depositing a clad on the circular target rod;
a sintering step of sintering the clad deposited on the circular target rod by a sintering unit arranged adjacent to the deposition burner while being integral with the deposition burner; and repeatedly carrying out the deposition step and the sintering step, in this order.

2. The method according to claim 1, wherein the deposition and sintering steps are carried out by reciprocating the deposition burner in a longitudinal direction of the circular target rod in accordance with a guiding operation of a rotating rail rotated in normal and reverse directions at intervals predetermined by a feeding motor, while rotating the circular target rod by a rotating motor connected to the circular target rod, and by reciprocating the sintering unit in the longitudinal direction of the circular target rod in accordance with the guiding operation of the rotating rail, while rotating the circular target rod by the rotating motor, respectively.

3. The method according to claim 1, wherein the sintering unit comprises a hydrogen/oxygen flame burner having a hollow semi-cylindrical shape that allows the circular target rod to extend through the hydrogen/oxygen flame burner.

4. The method according to claim 1, wherein the sintering unit comprises a furnace having a hollow cylindrical shape so that the circular target rod extends through the furnace

5. The method according to claim 4, wherein the furnace uses a heating source that doesn't generate H₂O or hydroxyl groups (OH) during a heating operation thereof.

6. The method according to claim 4, wherein the furnace is supplied with dehydrating gas so that dehydration occurs simultaneously with the sintering step in the furnace.

7. The method according to claim 6, wherein the dehydrating gas is one or more gaseous materials selected from a group consisting of He, Cl₂, SiCl₄, GeCl₄, BCl₃, HCl, POCl₃, PCl₃, TiCl₄, and AlCl₃.

8. The method according to claim 1, wherein the sintering unit has an internal temperature of 1,200 to 1,700° C. at the sintering step.

9. An apparatus for manufacturing an optical fiber preform, using an outside vapor deposition process, comprising:
a deposition burner for injecting soot onto a circular target rod, thereby depositing a clad on the circular target rod; and
a sintering unit arranged adjacent to the deposition burner, and adapted to sinter the clad deposited on the circular target rod,
wherein the deposition burner and the sintering unit are continuously and repeatedly reciprocated, in this order.

10. The apparatus according to claim 9, wherein the reciprocation of the deposition burner and sintering unit is carried out in a longitudinal direction of the circular target rod in accordance with a guiding operation of a rotating rail rotated in normal and reverse directions at intervals predetermined by a feeding motor, and the circular target rod rotates during the reciprocation of the deposition burner and sintering unit by a rotating motor connected to the circular target rod.

11. The apparatus according to claim 9, wherein the sintering unit comprises a hydrogen/oxygen flame burner having a hollow semi-cylindrical shape so that the circular target rod extends through the hydrogen/oxygen flame burner.

12. The apparatus according to claim 9, wherein the sintering unit comprises a furnace having a hollow cylindrical shape so that the circular target rod extends through the furnace.

13. The apparatus according to claim 12, wherein the furnace includes a heating source that doesn't generate H₂O or hydroxyl groups (OH) during a heating operation thereof.

14. The apparatus according to claim 12, wherein the furnace includes a dehydrating gas supply nozzle adapted to supply dehydrating gas into the furnace.

15. The apparatus according to claim 14, wherein the dehydrating gas is one or more gaseous materials selected from a group consisting of He, Cl₂, SiCl₄, GeCl₄, BCl₃, HCl, POCl₃, PCl₃, TiCl₄, and AlCl₃.

16. The apparatus according to claim 9, wherein the sintering unit has an internal temperature of 1,200 to 1,700° C.
